(19) United States
(12) Patent Application Publication
(10) Pub. No.: US 2024/0125680 A1
(43) Pub. Date: Apr. 18, 2024

(54) SYSTEM FOR DILUTION IN A DEVICE AND METHOD FOR MANUFACTURING THE DEVICE

(71) Applicants: BIOMERIEUX, Marcy L'Etoile (FR); BIOMERIEUX, INC., Durham, NC (US)

(72) Inventors: Patrick BROYER, Saint-Cassien (FR); Frederic FOUCAULT, Marcy L'Etoile (FR); Pierre IMBAUD, Pommiers (FR); Hervé ROSTAING, Le Versoud (FR); Kirk RIRIE, Salt Lake City, UT (US)

(73) Assignees: BIOMERIEUX, Marcy L'Etoile (FR); BIOMERIEUX, INC., Durham, NC (US)

(21) Appl. No.: 17/769,461

(22) PCT Filed: Oct. 27, 2020
(86) PCT No.: PCT/FR2020/000254

§ 371 Date: Apr. 15, 2022

(30) Foreign Application Priority Data
Oct. 29, 2019 (FR) 1912110

(51) Int. Cl. G01N 1/38; B01L 3/00

(52) U.S. Cl. CPC G01N 1/38; B01L 3/50273; B01L 2200/0621; B01L 2300/0816; B01L 2300/123; B01L 2400/0481; G01N 2001/381

(57) ABSTRACT

A system for diluting a sample of biological material, including a fluid circuit, wherein the fluid circuit includes at least: a first container configured to contain a sample of biological material containing a biological material to be diluted, the sample being a fluid; a second container configured to contain a first dilution fluid; and at least one first metering member for metering a predetermined volume of fluid, including a first wall and a second wall, the first metering member including a metering zone configured to change at least from an initial state in which the first wall and the second wall are in contact with one another to an operating state in which the first wall and the second wall are separated from one another.

### TECHNICAL FIELD OF THE INVENTION

The invention relates to the technical field of systems used for performing metering for the purposes of precise dilution for carrying out biological tests for the quantification of endotoxins present in a sample. The invention can also be applied to metering in immunoassay tests or in the preparation of a sample or of reagents for subsequent analysis.

### CONTEXT OF THE INVENTION

There are a number of biological tests by which it is possible to quantify endotoxins. Detection of endotoxins nowadays mainly involves the use of limulus amebocyte lysate (LAL), the LAL test being an in vitro test for quantifying the concentration of endotoxin present in a sample.

Other tests use recombinant enzyme chemistry in order to do without the blood of the horseshoe crab, in order to limit the number of invalid results associated with the inherent variability of the blood extraction process, and also in order to protect this endangered species.

Among these other tests, there are bacterial endotoxin detection tests which are based on an enzyme/substrate reaction and reading of a fluorescent signal. The advantage of this method is that it uses a recombinant factor C (rFC) which is produced entirely without using blood of the horseshoe crab. Recombinant factor C (rFC) is used with a synthetic fluorogenic substrate in order to detect the endotoxins.

However, the commercial test kits based on this method still necessitate a lot of manipulation (pipetting, mixing) and require considerable technique, which inevitably increases the risk of human error. Collection of data and the calculations for obtaining a result are also limiting factors for users who are seeking very specific performance.

For some years now there has been a test developed by the applicant, called ENDOZYME® II GO, which uses a system called “GOPLATE™”, which is a microplate comprising 96 wells pre-filled with the standard quantities required and positive controls for the concentration of product.

However, this system, requiring additional accessories (pipets, vortices, cones, etc.) and allowing several samples to be analyzed in a “batch”, is not suitable for “on-line” unit tests, that is to say tests carried out directly using a sample in a room and on the production line of the products that are to be checked. The line operators and the working environment require a new test concept that is extremely simple and rapid.

### OBJECT OF THE INVENTION

The object of the invention is to remedy all or some of the aforementioned drawbacks, and in particular to eliminate upstream preparation of the sample in order to save time, by proposing a novel and compact single-use device that comprises an integrated, precise, reproducible, autonomous, economical and disposable metering system (which can serve in particular for dilution). The invention can also be applied to immunoassays and molecular diagnostics or to a complete quantitative test of bacterial endotoxins, while at the same time guaranteeing performance levels and complying with the standards imposed by the Pharmacopoeia, in a short time and with a sensitivity of 0.005 EU/ml.

To this end, the invention relates to a dilution system for diluting a sample of biological material, comprising a fluidic circuit, characterized in that said fluidic circuit of the dilution system comprises at least:
a first container configured to contain a sample of biological material containing a biological material to be diluted, the sample being a fluid,
a second container configured to contain a first dilution fluid, the first container and the second container being fluidically connected by at least one fluid path,
at least a first metering member for metering a determined volume of fluid, comprising a first wall and a second wall, the first metering member comprising a metering zone configured to change at least from an initial state, in which the first wall and the second wall are in contact against each other, to an operating state, in which the first wall and the second wall are at a distance from each other in such a way as to delimit a determined metering volume, the metering zone attaining the operating state by the conveying of the sample and/or of a dilution fluid into said metering zone, the first metering member being arranged on the fluid path connecting the first container to the second container, between the first container and the second container.

Advantageously, the first metering member permits precise and rapid isolation of a fluid to be diluted and/or dilution fluid, and this in a reproducible manner, the walls of the metering member moving apart from each other only when the fluid to be metered is conveyed into the metering member. By design, the metering zone of the metering member remains in a stable position (operating state) and guarantees a reproducible volume without excessive pressure on the upstream container. In addition, the absence of air in the metering zone in the initial state, and therefore in the operating state, also entails the absence of bubbles in the downstream dilution system, which is highly advantageous.

According to one feature of the invention, in the initial state, the metering zone is without air. In addition, according to one feature of the invention, in the operating state, the metering zone is without air.

According to one feature of the invention, in the initial state, the first wall and the second wall of the metering member, at the level of the metering zone, form a concavity such as a hemispherical concave cap. In fact, each wall making up the metering member is in the form of a hemispherical concave cap, one on top of the other in the same direction, thus forming a hollow.

According to one feature of the invention, in the operating state, the volume of the metering zone is substantially spherical, like a bubble.

According to one feature of the invention, the dilution system is formed by a fluidic circuit integrating the containers, the mixing chamber(s), the metering member(s) and also the fluidic channels conveying the fluid(s) between the containers, the mixing chamber(s) of the channels, the metering member(s), and a reaction chamber.

According to one feature of the invention, the fluidic circuit is produced by laser welding or thermal welding or ultrasonic welding of the films making up the device in the form of a flexible bag.

According to one feature of the invention, the metering zone is delimited by welding the walls of the metering zone at its periphery. The welding makes it possible to circumscribe the fluid in the interior of the metering zone and to obtain a reproducible volume.

According to one feature of the invention, the determined volume of the metering zone in the operating state is invariable and reproducible, which guarantees the precision of the metering and the robustness of the dilution system.

Advantageously, the first metering member is arranged upstream of the first mixing chamber and downstream of the second container, which makes it possible to convey fluids previously metered, for example the dilution fluid or the sample, into the first mixing chamber.

According to one feature of the invention, the first metering member comprises at least one fluid inlet connected to the first fluid path serving the first container and the second container. Preferably, the first metering member comprises a fluid inlet connected directly to the first container, and a fluid inlet connected directly to the second container.

According to one feature of the invention, each fluid inlet of the first metering member, in the initial state of the metering zone of the first metering member, is hermetically closed by a fragile valve, said fragile valve being configured to be opened, preferably irreversibly, by the pressure of the fluid, from between the sample or the first dilution fluid, conveyed to the first metering member.

According to one feature of the invention, the dilution system comprises at least a first mixing chamber configured to contain a first mixture of fluid resulting from the mixing of part of the sample and at least part of the first dilution fluid, the first mixing chamber being fluidically connected to the first container and to the second container.

According to one feature of the invention, the second container is configured to contain the first dilution fluid and to serve as first mixing chamber.

According to one feature of the invention, the first mixing chamber is fluidically connected to the first container and to the second container by the same fluid path or by a fluid path different than the one that connects the first container to the second container.

According to one feature of the invention, the first mixing chamber is configured to receive a determined and metered volume of sample coming from the first container, metered by the first metering member, and a determined and metered volume of first dilution fluid coming from the second container.

According to one feature of the invention, the first metering member comprises at least one fluid outlet connected to the first mixing chamber. Advantageously, each fluid outlet of the first metering member, in the initial state of the metering zone of the first metering member, is hermetically closed by a fragile valve, said fragile valve being configured to be opened, preferably irreversibly, by the pressure of a fluid from between the sample or the first dilution fluid or the first mixture of fluid, conveyed to the first mixing chamber.

According to one feature of the invention, the at least one fluid outlet opens directly into the first mixing chamber.

According to one feature of the invention, the dilution system comprises a third container configured to contain a second dilution fluid.

According to one feature of the invention, the dilution system comprises at least a second chamber for mixing the second dilution fluid with the first mixture, the second mixing chamber being fluidically connected to the first mixing chamber via a second metering member and to the third container.

According to one feature of the invention, the second container is configured to contain the first dilution fluid and to serve as second mixing chamber.

According to one feature of the invention, the dilution system comprises a second metering member arranged upstream of the second mixing chamber, and preferably between the second mixing chamber and the third container.

According to one feature of the invention, the second metering member is identical to the first metering member in terms of its operation.

According to one feature of the invention, the dilution system comprises a single first metering member.

According to one feature of the invention, the single first metering member is arranged downstream of the containers.

According to one feature of the invention, the second metering member is configured to meter the first mixture of fluid coming from the first mixing chamber and intended to be diluted by the second dilution fluid coming from the third container.

Advantageously, the second dilution fluid can be metered by the second metering member or the volume of the second dilution fluid can be predetermined and metered before its introduction into the device.

According to one feature of the invention, the second metering member comprises at least one fluid inlet connected directly or indirectly to the fluid path serving the third container, and a fluid inlet connected directly or indirectly to the first mixing chamber.

According to one feature of the invention, each fluid inlet of the second metering member, in the initial state of the metering zone of the second metering member, is hermetically closed by a fragile valve, said fragile valve being configured to be opened, preferably irreversibly, by the pressure of the fluid conveyed to the second metering member.

According to one feature of the invention, the second metering member comprises at least one fluid outlet opening directly into the second mixing chamber. Advantageously, each fluid outlet of the second metering member, in the initial state of the metering zone of the second metering member, is hermetically closed by a fragile valve, said fragile valve being configured to be opened, preferably irreversibly, by the pressure of the fluid contained toward the second mixing chamber.

Advantageously, in order to have a ten-fold dilution of the sample, the first metering member has for example a volume of 10 μl, by which 10 μl of sample are taken from the first container and poured into the first mixing chamber. Then, 90 μl of first dilution fluid are taken from the second container and are poured into the first mixing chamber containing the 10 μl of sample.

Advantageously, in order to have a hundred-fold dilution of the sample, the second metering member has for example a volume of 10 μl, by which 10 μl of the first mixture obtained beforehand (ten-fold dilution) are taken from the first mixing chamber and poured into the second mixing chamber. Then, 90 μl of the second dilution fluid are taken from the third container and are poured into the second mixing chamber containing the 10 μl of the first mixture. A second mixture is thus obtained with a hundred-fold dilution of sample.

The first container has a maximum capacity of 500 μl, preferably 200 μl. According to the invention, the first container comprises between 20 μl and 200 μl of sample, preferably about 100 μl of sample.

The second container has a maximum capacity of 500 μl, preferably 180 μl. According to the invention, the second container comprises between 20 μl and 200 μl, even more preferably between 90 μl and 180 μl of dilution fluid, preferably about 90 μl of dilution fluid.

The third container has a maximum capacity of 500 μl, preferably 180 μl. According to the invention, the second container comprises between 20 μl and 200 μl, even more preferably between 90 μl and 180 μl, preferably about 90 μl of dilution fluid.

Preferably, and according to the invention, the second container and the third container have an identical capacity.

Preferably, the first dilution fluid and/or the second dilution fluid is a liquid. For example, the first dilution fluid and/or the second dilution fluid is preferably sterile water without any trace of endotoxin (endotoxin-free water) or a dilution buffer without any trace of endotoxin, in an application where the analyte sought is an endotoxin.

Advantageously, the second dilution fluid is identical to the first dilution fluid. Alternatively, the second dilution fluid is different than the first dilution fluid.

The invention also relates to a device in the form of a flexible bag comprising at least a first film and a second film laminated with each other at least partially, characterized in that the device comprises the dilution system according to the invention, and a reaction chamber, said dilution system being fluidically connected to the reaction chamber.

Advantageously, the device according to the invention makes it possible to obtain a detection of endotoxins of between 0.005 EU/ml and 50 EU/ml in about 20 minutes, by virtue of the dilution system and the associated reaction chamber. In addition, the device permits automation of the entire detection process, and human intervention is thus reduced to collecting the sample to be analyzed and introducing it into the first container of the dilution system (load & go system).

According to one feature of the invention, the reaction chamber of the device is a component preferably made of plastic.

According to one feature of the invention, the reaction chamber comprises a plurality of wells configured to accommodate at least one reagent.

According to one feature of the invention, the device uses a chemical reaction according to which the reagents are based on the recombinant factor rFC, in order to detect whether the sample contains endotoxins. Of course, the invention is applicable to any type of analysis requiring at least one dilution and a search by chemical reaction, and, where appropriate, the reagents would be adapted to the element sought in the sample.

According to one feature of the invention, the device is configured to cooperate with a first plurality of mechanical valves positioned upstream of the fragile valves of the first metering member.

Each mechanical valve of the first plurality is placed at a fluid inlet or outlet of the first metering member and is configured to allow/prohibit a fluid to enter the first metering member or to allow/prohibit a fluid to exit the first metering member.

Advantageously, according to the invention, a first mechanical valve positioned at a fluid inlet of the first metering member is coupled to a mechanical valve positioned at the fluid outlet of the first metering member.

According to one feature of the invention, the device is configured to cooperate with a second plurality of mechanical valves positioned upstream of the fragile valves of the second metering member.

Each mechanical valve of the second plurality is placed at a fluid inlet or outlet of the second metering member and is configured to allow/prohibit a fluid to enter the second metering member or to allow/prohibit a fluid to exit the second metering member.

According to one feature of the invention, the fragile valves of the dilution system are arranged transversely to a fluidic channel in such a way as to allow or prohibit the flow of a fluid in said channel.

According to one feature of the invention, each fragile valve is created during the lamination of the two films.

According to one feature of the invention, the mechanical valves are arranged transversely to a fluidic channel in such a way as to allow or prohibit the flow of a fluid in said channel.

The invention also relates to an instrumentation system comprising the device according to the invention and an analysis instrument comprising the mechanical valves of the first plurality and/or of the second plurality and/or of the third plurality, and at least one insertion zone into which the device is inserted and cooperates with each of the mechanical valves.

The invention also relates to a method for manufacturing a device according to the invention incorporating the dilution system according to the invention, the manufacturing method comprising:
creating a fluidic circuit of the dilution system according to the invention on the films of the device, by welding said films, said films being at least partially laminated beforehand,
forming at least the first metering member, in which: (i) at least the metering zone of the first metering member created in the step of creating the fluidic circuit is positioned in a mold, said mold comprising at least two mold parts, each having at least one mold cavity, the mold cavity of the first mold part being arranged at least partially facing the mold cavity of the second mold part and being at least partially complementary to the mold cavity of the second mold part, (ii) by closing the two parts of the mold toward each other, the two films of the device are deformed together on one side or the other of the device, in a single direction of deformation, at the level of the metering zone by a deformation element, the deformation element being arranged between the device and the second mold part or between the device and the first mold part.

By means of this method, the metering member remains in a stable position and guarantees a determined reproducible volume without excessive pressure on the upstream container from which the fluid is conveyed to the metering member. The absence of air, which is due to the prior lamination followed by the creation of the fluidic circuit by welding, also entails the absence of bubbles in the downstream dilution system, which guarantees quality and precision in the metering of fluids and in the dilution.

According to one feature of the invention, the deformation element advantageously comes into contact with the outer surface of one of the two films of the device in order to deform the two films in a single direction and simultaneously.

Advantageously, only the metering member or metering members are produced by the forming step; the other chambers or containers are produced differently, for example by blowing between the two films of the device or by symmetrical plastic deformation, etc.

Advantageously, the deformed metering zone is in the form of a multilayer hemispherical concave cap, that is to say composed of the various laminated and deformed films corresponding to the walls of the metering member, and this without folds or air.

Advantageously, when the metering zone of the first metering member and/or of the second metering member changes to the operating state, that is to say when a fluid reaches one of the metering zones and the volume of the latter fills up, a characteristic popping noise occurs, which is linked to the separation of the walls of the metering member and to the deformation of the concavity of one of them in the other direction.

According to one feature of the invention, the deformation of the metering zone is a plastic deformation.

According to one feature of the invention, the deformation of the metering zone of each metering member of the dilution system is carried out by die sinking by the deformation element.

According to one feature of the invention, the deformation element is integrated into one of the mold parts.

According to one feature of the invention, each mold part is heated. Thus, the deformation element provided on one of the mold parts is then itself heated.

According to one feature of the invention, each metering zone is formed by deformation by means of a dedicated deformation element.

Preferably, the deformation element is a protruding lug formed on the first mold part or on the second mold part, the lug protruding from the surface of the mold cavity of the first mold part or second mold part respectively. Even more preferably, the deformation element is a ball.

According to one feature of the invention, the lug protrudes from the surface of the mold cavity in a secant and preferably perpendicular direction.

According to one feature of the invention, each deformation element is integrated in the second mold part, each deformation element protruding from the surface of the second mold part and configured to cooperate with a complementary mold cavity provided on the first mold part. Thus, when the second mold part is brought closer to the first mold part, the one or more balls, which are positioned opposite the one or more metering zones to be deformed, deform the one or more metering zones of the device by pushing the films of the device into the complementary mold cavity of the first mold part.

Alternatively, the deformation element is a fluid, preferably a gas, and the deformation of the metering zone is carried out by blowing of said fluid.

Advantageously, the blowing is carried out on the outer surface of one of the two films of the device in a single direction of deformation, so that the two films are deformed simultaneously.

According to one feature of the invention, the blowing can be carried out hot.

According to one feature of the invention, the fluid can even more preferably be pressurized air, preferably between 4 and 10 bar.

Advantageously, the second mold part or the first mold part comprises an open channel provided on the surface facing respectively the first mold part or the second mold part, the fluid configured to deform the one or more metering zones being blown and guided into said open channel.

According to one feature of the invention, the blowing fluid can be heated. Thus, the fluid softens and pushes the two films toward one of the mold parts and in particular into the mold cavity of the mold part conformed to the shape of the metering zone.

According to one feature of the invention, the method comprises a cooling step, called passive cooling.

According to one feature of the invention, before deformation of the bag in the mold, the laminated films of the device are preheated between 25° C. and 100° C., preferably between 40° C. and 80° C., for a determined period, preferably between 2 and 6 seconds. The preheated and laminated films are then conveyed between the two mold parts, the mold itself preferably thermoregulated at a temperature of between 25° C. and 80° C. The films are maintained at temperature by contact when the mold is closed, and the deformation element in the form of fluid is injected for 2 to 6 seconds, permitting the deformation of the films at the level of each metering zone.

In the present invention, the term “sample” is understood to mean a sample of biological material.

In the present invention, the terms upstream and downstream are used according to the direction of flow of the fluids.

In the present invention, the term “flexible bag” is understood to mean a bag which folds without being plastically deformed and which has the property of partially or totally recovering its shape or its volume, after it has lost them by compression or by extension.

In the present invention, the term “dilution fluid” is understood to mean a fluid, preferably a liquid, which permits a dilution of a substance by its addition to said substance.

In the present invention, the term “biological material” is understood to mean any material containing biological information.

In the present invention, the term “biological information” is understood to mean any element constituting said biological material or produced by the latter, such as membrane elements of microorganisms, nucleic acids (DNA, RNA), proteins, peptides or metabolites. The biological information can in particular be contained within said biological material or excreted/secreted by the latter.

In the present invention, the term “fragile valve” is understood to mean a weld arranged transversely to a fluidic channel and blocking/allowing flow of a fluid within said channel, the valve being called “fragile” because it opens as soon as a fluid is conveyed into contact with it at a pressure of the order of about 10N to 20N, sometimes more, depending in particular on the lamination, the material used to make the device, and the geometry of the fluidic circuit, etc. A fragile valve is a single-action valve which, once opened, cannot close again.

In the present invention, the term “mechanical valve” is understood to mean a valve arranged transversely to a fluidic channel in order to allow or prohibit the flow of a fluid in a fluidic channel, said mechanical valve being actuatable and reversible, that is to say it can open and close on command. In the present invention, the mechanical valves support the fragile valves when the latter are closed and take over from the fragile valves when the latter are permanently opened.

In the present invention, the term “weld” is understood to mean a permanent weld of the films, making it possible to limit the circulation of the fluid and to circumscribe it within the fluidic circuit thus created. The “weld” can be produced by laser, by heat welding or by any other method allowing an equivalent result to be obtained.

### BRIEF DESCRIPTION OF THE FIGURES

The invention will be better understood from the following description, which relates to embodiments of the present invention that are given as non-limiting examples and are explained with reference to the appended schematic figures. The appended schematic figures are listed below:

FIG. 1 is a diagram illustrating a first configuration of the dilution system according to the invention,

FIG. 2 is a diagram illustrating a second configuration of the dilution system according to the invention,

FIG. 3A is a diagram illustrating a third configuration of the dilution system according to the invention,

FIG. 3B is a diagram illustrating a variant of the third configuration of the dilution system according to the invention,

FIG. 4 is a diagram illustrating a fourth configuration of the dilution system according to the invention,

FIG. 5 is an illustration of the device according to the invention incorporating a dilution system according to the third configuration,

FIG. 6 is an illustration of the device according to the invention incorporating a dilution system according to the second configuration,

FIG. 7 is a detail view of the dilution system illustrated in FIG. 3, indicating the positioning of the fragile valves,

FIG. 8 is a detail view of the dilution system illustrated in FIG. 3, indicating the positioning of the mechanical valves with respect to the fragile valves,

FIG. 9 is a cross-sectional diagram of a metering member, according to any one of the configurations of the dilution system according to the invention, in the initial state,

FIG. 10 is a cross-sectional diagram of a metering member in the operating state when it contains a dose of fluid,

FIG. 11 is a partial illustration of the dilution system according to the third configuration according to a first operating step,

FIG. 12 is a partial illustration of the dilution system according to the third configuration according to a second operating step,

FIG. 13 is a partial illustration of the dilution system according to the third configuration according to a third operating step,

FIG. 14 is a partial illustration of the dilution system according to the third configuration according to a fourth operating step,

FIG. 15 is a partial illustration of the dilution system according to the third configuration according to a fifth operating step,

FIG. 16 is a partial illustration of the dilution system according to the third configuration according to a sixth operating step,

FIG. 17 is a partial illustration of the dilution system according to the third configuration according to a variant of the fifth operating step,

FIG. 18 is a partial illustration of the dilution system according to the third configuration according to a variant of the sixth operating step, succeeding the variant of the fifth operating step,

FIG. 19 is a partial illustration of the dilution system according to the third configuration according to a ninth operating step,

FIG. 20 is a partial illustration of the dilution system according to the third configuration according to a tenth operating step,

FIG. 21 is a partial illustration of the dilution system according to the third configuration according to an eleventh operating step,

FIG. 22 is a partial illustration of the dilution system according to the third configuration according to a twelfth operating step,

FIG. 23 is a partial illustration of the dilution system according to the third configuration according to a thirteenth operating step,

FIG. 24 is a partial illustration of the dilution system according to the third configuration according to a variant of the twelfth operating step,

FIG. 25 is a partial illustration of the dilution system according to the third configuration according to a variant of the thirteenth operating step, succeeding the variant of the twelfth operating step,

FIG. 26 is a partial illustration of the dilution system according to the third configuration according to a fourteenth operating step,

FIG. 27 illustrates the fluidic link between the sample container and the reaction chamber of the device according to the invention,

FIG. 28 illustrates the fluidic link between the first mixing chamber and the reaction chamber of the device according to the invention,

FIG. 29 illustrates the fluidic link between the second mixing chamber and the reaction chamber of the device according to the invention,

FIG. 30 is a sectional view of a mold in which is at least partially inserted a device according to the invention regardless of the configuration of the dilution system, according to a first embodiment and according to a second implementation step,

FIG. 31 is a sectional view of a mold in which is at least partially inserted a device according to the invention regardless of the configuration of the dilution system, according to the first embodiment and according to a third implementation step,

FIG. 32 is a perspective diagram of the two mold parts used in the first embodiment of the device according to the invention,

FIG. 33 is a sectional view of a mold in which is at least partially inserted a device according to the invention regardless of the configuration of the dilution system, according to a second embodiment and according to a second implementation step,

FIG. 34 is a sectional view of a mold in which is at least partially inserted a device according to the invention regardless of the configuration of the dilution system, according to the second embodiment and according to a third implementation step,

FIG. 35 is a top view of the mold illustrated in FIGS. 33 and 34, according to the second embodiment of the device according to the invention.

### DETAILED DESCRIPTION

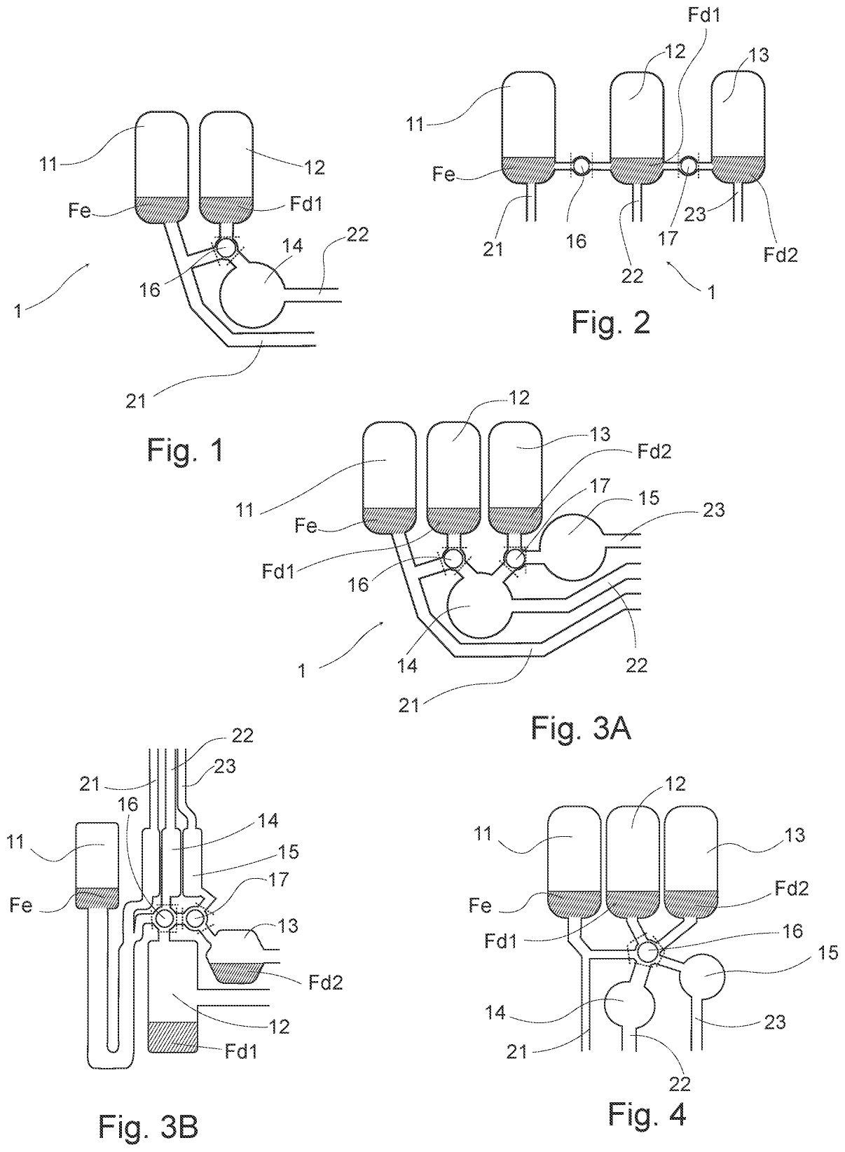

The invention will now be described with reference to FIGS. 1 to 35.

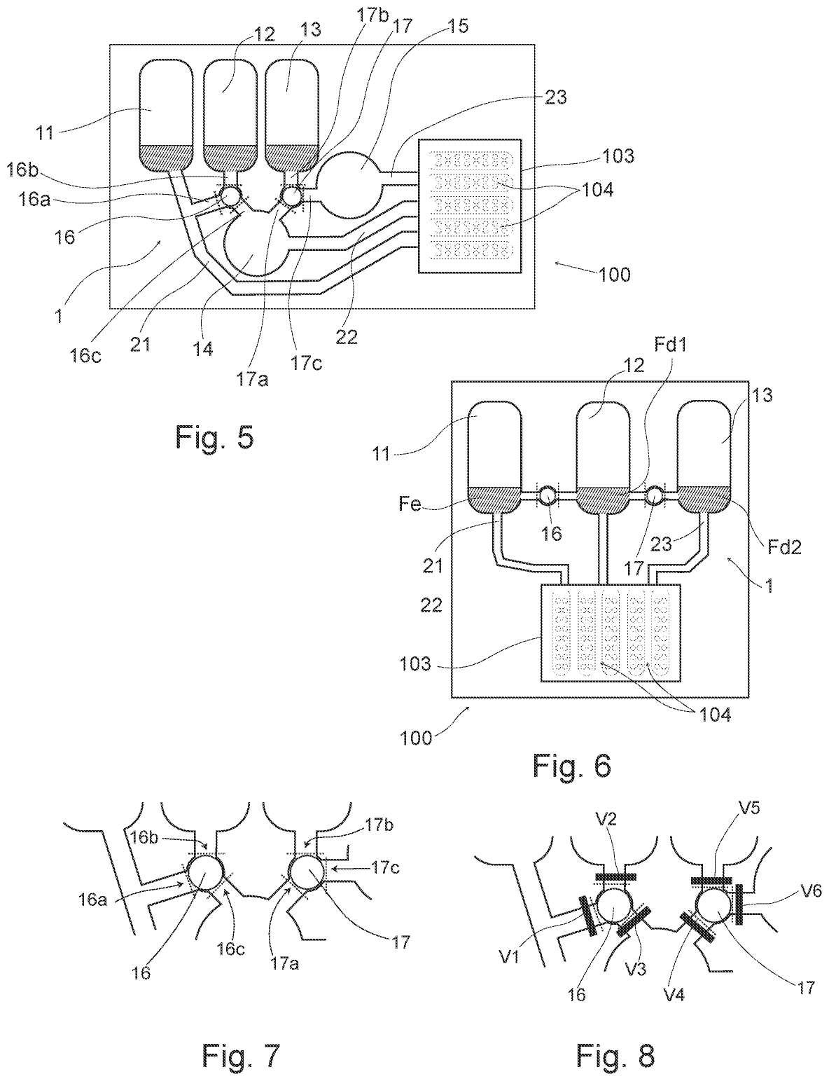

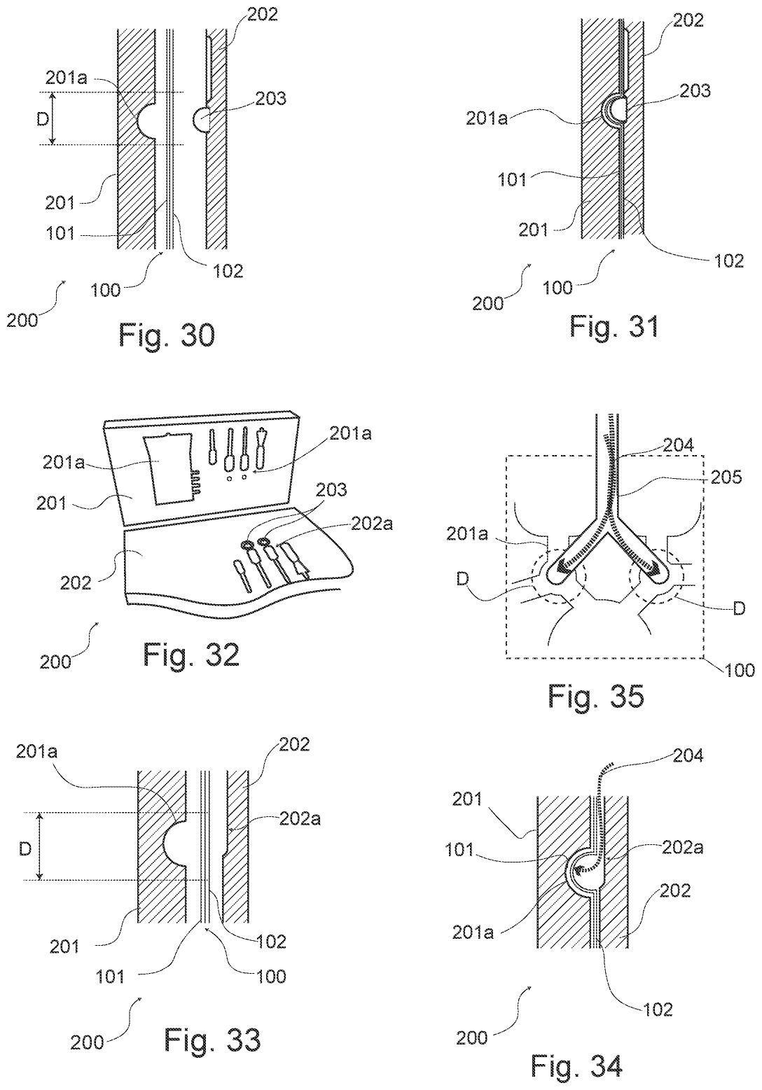

The dilution system 1 according to the invention is illustrated in particular in FIG. 1 according to a first configuration, a second configuration in FIG. 2, a third configuration in FIG. 3, and a fourth configuration in FIG. 4, and then in more detail in FIGS. 5 to 29. The device 100 according to the invention, incorporating any one of the dilution systems 1 according to the invention, is shown in FIG. 5 and in FIG. 6. In addition, steps of the method for manufacturing the dilution system are illustrated in FIGS. 30 to 35.

The device 100 according to the invention is configured to permit the dilution of a sample to be analyzed and to demonstrate analytes (for example endotoxins), which may be present in said sample, for diagnostic purposes. According to the invention, and whatever the configuration of the dilution system, the device 100 comprises a dilution system 1, and a reaction chamber 103 fluidically connected to the dilution system 1 as illustrated in FIG. 5 and in FIG. 6. The device 100 according to the invention is produced in the form of a flexible bag comprising at least a first film 101 and a second film 102 which are at least partially laminated with each other.

In the example illustrated in FIG. 5, the device 100 incorporates a dilution system 1 according to a third configuration. In the example illustrated in FIG. 6, the device 100 incorporates a dilution system 1 according to a second configuration. Of course, the device can incorporate a dilution system according to the first configuration or according to another configuration comprising more metering members and containers and mixing chambers, without thereby departing from the scope of the invention.

According to the invention, the dilution system 1 is connected to the reaction chamber by means of fluidic channels 21 and 22 for the first configuration and 21, 22 and 23 for the second configuration and the third configuration. Each fluidic channel 21, 22, 23 opens onto one or more rows of dedicated wells 104 of the reaction chamber 103, as is illustrated in particular in FIGS. 5, 6 and 25 to 27. This aspect will be developed later in the description.

The dilution system 1 according to the invention will now be described with reference to FIGS. 1, 2, 3 and 4. The only difference between the first configuration of the dilution system 1 (FIG. 1) and the third configuration of the dilution system 1 (FIG. 3) is the fact that the dilution system 1 according to the first configuration permits only one dilution, since it comprises only a single dilution member 16 and a single dilution fluid container. The only difference between the second configuration of the dilution system 1 (FIG. 2) and the third configuration (FIG. 3) is the fact that there is no separate mixing chamber in the second configuration. In fact, in the second configuration, the containers in which the dilution fluids are arranged serve as mixing chambers. The difference between the fourth configuration (FIG. 4) and the other configurations is the fact that the latter has only a single dilution member allowing several dilutions to be carried out.

Whatever the configuration of the dilution system 1 according to the invention, said dilution system 1 comprises a fluidic circuit connecting fluid containers and fluid mixing chambers. Preferably, the fluidic circuit is produced by welding the two films, of the device 100, laminated together.

Whatever the configuration of the dilution system 1 according to the invention, the dilution system 1 comprises a first container 11 configured to contain a sample of biological material containing a biological material to be diluted, the sample being a fluid designated Fe in the figures.

In addition, whatever the configuration of the dilution system 1 according to the invention, said dilution system 1 comprises at least a second container 12 configured to contain a first dilution fluid designated Fd1 in the figures.

Advantageously, the dilution system 1 comprises as many dilution fluid containers as there are dilutions to be carried out and/or different dilution fluids.

Whatever the configuration of the dilution system 1 according to the invention, the first container 11 comprises a fluid inlet configured to receive a sample to be analyzed in the form of fluid or to receive a member containing said sample to be analyzed, for example a pipet. Advantageously, the fluid inlet of the first container 11 can be sealed once the sample has been introduced into said first container 11, as is illustrated in the figures, or else can remain open. In addition, the first container 11 comprises a fluid outlet.

Whatever the configuration of the dilution system 1 according to the invention, the second container 12 is configured to contain a determined volume of a first dilution fluid Fd1 and comprises a fluid inlet and a fluid outlet. Like the first container 11, the fluid inlet of the second container 12 is preferably sealed once the dilution fluid has been introduced into the second container 12.

Whatever the configuration of the dilution system 1 according to the invention, the dilution system 1 comprises a first metering member 16. The first metering member 16 is arranged on the fluid path connecting the first container 11 and the second container 12, and in particular between the first container 11 and the second container 12, as can be seen in particular in FIGS. 1, 2, 3 and 4.

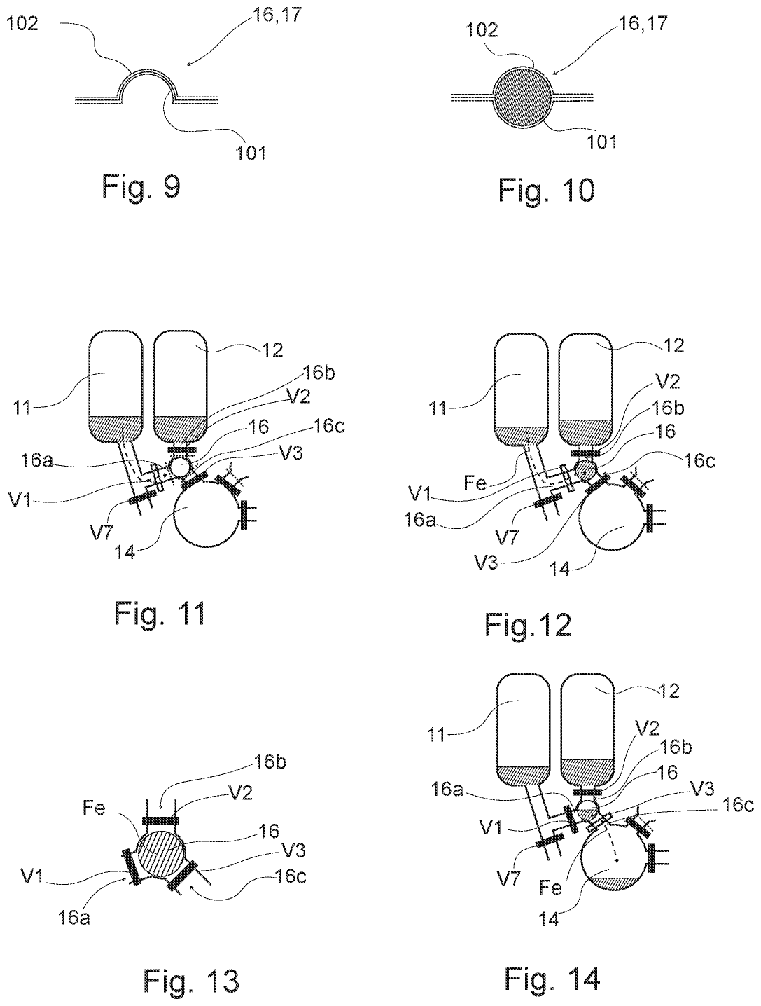

According to the invention, and whatever the configuration of the dilution system 1, each metering member 16, 17 comprises a first wall 101 and a second wall 102 corresponding, respectively, to a portion of the first film 101 and a portion of the second film 102 constituting the device 100 according to the invention, as can be seen in FIGS. 9 and 10.

In addition, whatever the configuration of the dilution system 1, each metering member 16, 17 comprises a metering zone configured to change from an initial state, in which the first wall 101 and the second wall 102 are in contact against each other (see FIG. 9), to an operating state, in which the first wall 101 and the second wall 102 are at a distance from each other so as to delimit a determined volume (see FIG. 10), the metering zone attaining the operating state by the conveying of the sample Fe and/or of a dilution fluid Fd1, Fd2 or a mixing fluid Fm1 into the volume of the metering member 16, 17. The deformation of the metering zone is reversible, and the metering zone can be reset to its initial state.

According to the invention, and according to the first, the third and the fourth configurations of the dilution system 1, the dilution system 1 comprises a first mixing chamber 14. In this first mixing chamber 14, the sample Fe to be analyzed is mixed with the first dilution fluid Fd1, in order to be diluted in a predetermined proportion according to the desired rate of dilution. The first mixing chamber 14 comprises a fluid inlet through which the sample Fe and the first dilution fluid Fd1 enter, and at least one fluid outlet through which the first fluid mixture Fm1 (shown in FIGS. 17 and 18 for example) exits.

According to the first, the third and the fourth configurations of the dilution system 1, the first metering member 16 is arranged upstream of the fluid inlet of the first mixing chamber 14, as can be seen in FIGS. 1, 3 and 4.

According to the second configuration of the dilution system 1, illustrated in FIG. 2 and in FIG. 6, the containers 12, 13 comprising the first dilution fluid Fd1 and the second dilution fluid Fd2 serve as a mixing chamber.

According to the third configuration, and as is illustrated in particular in FIG. 3A and FIG. 3B, the dilution system comprises a second metering member 17. In addition, the dilution system 1 comprises a third container 13 configured to contain a second dilution fluid Fd2. Advantageously, the second metering member 17 is arranged on the fluid path connecting the first mixing chamber 14 and the third container 13 and, in particular, the second metering member 17 is arranged between the first mixing chamber 14 and the third container 13.

According to the third configuration, the dilution system 1 comprises a second mixing chamber 15. In this second mixing chamber 15, the first fluid mixture Fm1 is mixed with the second dilution fluid Fd2 in order to be diluted in a predetermined proportion according to the desired rate of dilution.

As is illustrated in FIG. 3A and FIG. 3B, the second mixing chamber 15 comprises a fluid inlet through which the first fluid mixture Fm1 and the second dilution fluid Fd2 enter, and at least one fluid outlet through which a second fluid mixture Fm2 (not shown) exits.

In FIG. 3B, the first metering member 16 and the second metering member 17 are fluidically connected to each other in a direct manner.

In the examples illustrated, each metering member 16, 17 is placed upstream of the fluid inlet of a mixing chamber 14, 15. In these examples, the metering member is configured to meter the fluids coming from several containers successively. Of course, it could be envisioned that each container has a dedicated metering member, and the metering of each fluid could also be successive or else simultaneous (in this case, the mixing chambers would comprise several fluid inlets).

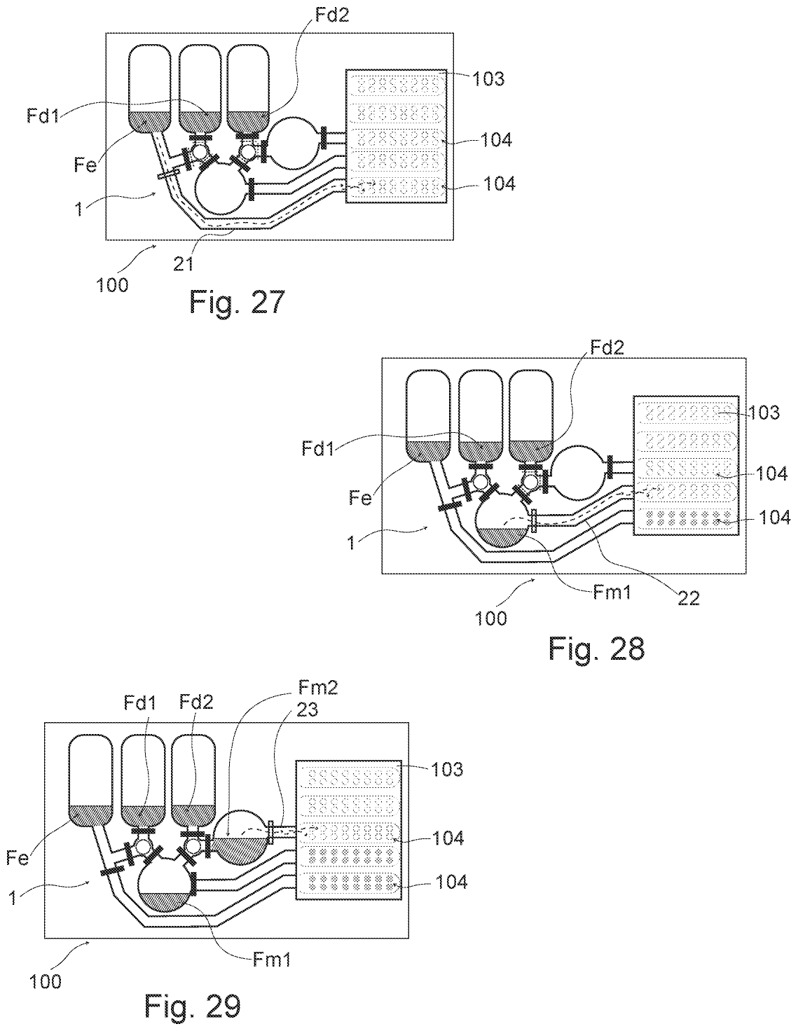

According to the third configuration of the dilution system 1, the first container 11 comprises two fluid outlets, specifically a first fluid outlet connected to a fluid inlet of the first metering member 16 and a second fluid outlet connected to a fluidic channel 21 directly conveying a part of the sample Fe to the reaction chamber 103 of the device 100, as is illustrated in FIG. 27.

According to the third configuration of the dilution system 1, the first mixing chamber 14 comprises two fluid outlets, specifically a first fluid outlet connected to a fluid inlet of the second metering member 17 and a second fluid outlet connected to a fluidic channel 22 directly conveying a part of the first fluid mixture Fm1 to the reaction chamber 103 of the device 100, as is illustrated in FIG. 28.

According to the third configuration of the dilution system 1, the second mixing chamber 15 comprises a fluid outlet connected to a fluidic channel 23 directly conveying the second mixture of fluid Fm2 to the reaction chamber 103 of the device 100, as is illustrated in FIG. 29.

According to the fourth configuration, illustrated in FIG. 4, the first metering member 16, which is the only metering member of the dilution system 1, comprises a first fluid inlet connected to the first container 11, a second fluid inlet connected to the second container 12, a third fluid inlet connected to the third container 13, a fourth fluid inlet connected to the first mixing chamber 14, which also serves as first fluid outlet, and a second fluid outlet connected to the second mixing chamber 15.

According to the invention, and whatever the configuration, each fluid inlet and outlet of each metering member 16, 17, in the initial state of the metering zone of the metering member 16, 17, is hermetically closed by fragile valves, which are shown in dotted lines and positioned transversely to the fluidic channel connecting a container to a metering member. Each fragile valve is configured to be opened by pressure of the fluid flowing from a container or a mixing chamber positioned fluidically upstream of the metering member in the direction of flow of the fluid, toward a mixing chamber positioned fluidically downstream of the metering member in the direction of flow of the fluid.

FIG. 7 illustrates the positioning of the fragile valves at the level of each fluid inlet 16a, 16b, 17a, 17b of each metering member 16, 17 and at the level of each fluid outlet 16c, 17c of each metering member 16, 17, for the third configuration. Of course, a similar arrangement can be applied for each configuration.

Each fragile valve is coupled to a mechanical valve V1 to V6. Thus, when these fragile valves are open, the mechanical valves V1, V2, V3, V4, V5, V6 take over in order to close or reopen the fluid inlets 16a, 16b, 17a, 17b and outlets 16c, 17c. FIG. 8 illustrates the positioning of the mechanical valves V1, V2, V3, V4, V5, V6, with respect to the fragile valves, when the metering zones of the first metering member 16 and of the second metering member 17 are in the initial state, for the third configuration. Of course, a similar arrangement can be applied for each configuration.

In this case, the device 100 is configured to cooperate with a first plurality of valves V1, V2 and V3, which are configured to close, respectively, a first fluid inlet 16a of the first metering member 16, a second fluid inlet 16b of the first metering member 16 and a fluid outlet 16c of the first metering member 16, as is illustrated in FIG. 11.

In addition, the device 100 is configured to cooperate with a second plurality of mechanical valves V4, V5 and V6, which are configured to close, respectively, a first fluid inlet 17a of the second metering member 17, a second fluid inlet 17b of the second metering member 17 and a fluid outlet 17c of the second metering member 17.

Furthermore, the device 100 is configured to cooperate with a third plurality of mechanical valves V7, V8, V9, which are positioned respectively at the inlet of the first fluidic channel 21, at the inlet of the second fluidic channel 22 or at the outlet of the first mixing chamber 14, and at the inlet of the third fluidic channel 23 or at the outlet of the second mixing chamber 15.

In the present description, the mechanical valves V1 to V9 are illustrated in two positions: an open position, illustrated by an empty/white rectangle, and a closed position, illustrated by a solid/black rectangle.

The principle of dilution according to the invention will now be described with reference to FIGS. 11 to 26. This principle will be illustrated with the dilution system 1 according to the third configuration, but of course this principle also applies to the dilution system 1 according to other configurations.

At the first use of the device 100, the dilution system 1 has not yet been used and the metering zones of the first metering member 16 and of the second metering member 17 are in the initial state and all the fragile valves are hermetically closed, as is illustrated in FIG. 4. Moreover, when the device 100 is inserted into the instrument permitting implementation of the dilution via the dilution system 1, the first plurality of valves V1 to V3, the second plurality of mechanical valves V4 to V6 and the third plurality of mechanical valves V7 to V9 are closed and positioned as shown in FIG. 8.

First, the first mechanical valve V1 is opened and at least the mechanical valves V2 and V3 are closed. Then, pressure is applied to the first container 11, which contains a sample Fe in the form of fluid. The sample Fe then passes through the fluidic circuit of the dilution system 1 as far as the first inlet 16a of the first metering member 16, as is illustrated in FIG. 11 at the level of the fragile valve positioned at the inlet 16a of the first metering member 16. Under the pressure exerted by the arrival of the sample fluid Fe, the fragile inlet valve 16a opens, as is illustrated in FIG. 12. This opening is sudden, and the sample Fe fills the entire determined internal volume of the metering zone of the first metering member 16, as is illustrated in FIG. 13, the valve V1 being closed as soon as the metering zone is filled. The metering zone of the first metering member 16 is in the operating state since the walls 101, 102 of the latter are at a distance from each other in order to delimit a metering volume as illustrated in FIG. 10, and all of the fragile valves positioned at the fluid inlet 16a, 16b and at the fluid outlet 16c of the first metering member 16 are opened and taken over respectively by the mechanical valves V1, V2 and V3 which are closed, as is illustrated in FIG. 13.

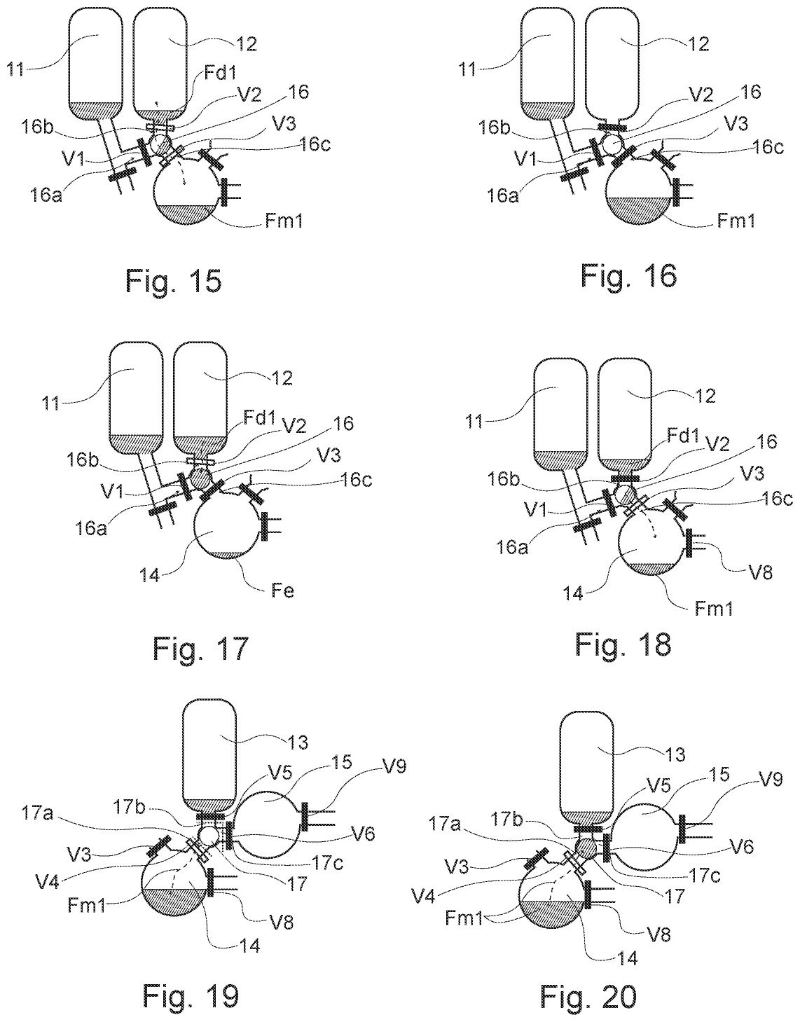

According to a first mode of operation illustrated in FIG. 15, the mechanical valves V2 and V3 are open even though the first metering member 16 contains the metered sample Fe, the mechanical valve V1 being closed. Then, a back and forth motion is effected between the first dilution fluid Fd1 contained in the second container 12, the first metering member 16 and the mixing chamber 14, so as to mix the first dilution fluid Fd1 with the metered sample Fe. This first mode of operation has the advantage of ensuring that the whole of the metered sample Fe is well diluted with the whole of the first dilution fluid Fd1. When the first mixture of fluid Fm1 is obtained and is collected in the first mixing chamber 14, the mechanical valves V2 and V3 are closed.

Alternatively, according to a second mode of operation, once the sample Fe has been metered, the mechanical valve V3 is opened so that the metered sample Fe pours into the first mixing chamber 14 (FIG. 14), then the mechanical valve V2 positioned at the second fluid inlet 16b of the first metering member 16 is opened, the mechanical valve V3 being open and the mechanical valve V1 being closed, and the back-and-forth operation is carried out as illustrated in FIG. 15 and as explained according to the first mode of operation. When the first mixture of fluid Fm1 is obtained and is collected in the first mixing chamber 14, the mechanical valves V2 and V3 are closed, as is illustrated in FIG. 16.

Alternatively, according to a third mode of operation, illustrated in FIG. 14, once the sample Fe has been metered, the mechanical valve V3 positioned at the fluid outlet 16c of the first metering member 16 is opened so that the metered sample Fe pours into the first mixing chamber 14, the mechanical valves V1 and V2 being closed. The metering zone of the first metering member 16 is then reset such that it is in the initial state, but with the fragile valves inactive. This reset can be achieved by a pusher element pushing back and repositioning the walls of the device on each other at the level of the metering zone.

The mechanical valve V2 positioned at the second fluid inlet 16b of the first metering member 16 is then opened, the mechanical valves V1 and V3 remaining closed. The opening of the mechanical valve V3 entails the metering zone of the first metering member 16 changing to the operating state, making it possible to sample only a precise dose of the first dilution fluid Fd1 contained in the second container 12, as is illustrated in FIG. 17. Once the volume of the metering zone has been filled, the mechanical valve V2 is closed in order to isolate the dose of first dilution fluid Fd1 in the first metering member 16, the mechanical valves V1 and V3 also being closed.

In this third mode of operation, provision can be made that the first metering member 16 is emptied by pressure exerted on its metering zone, this pressure being able to be exerted by the same pusher element that serves for resetting or by another element.

The mechanical valve V3 is then opened such that the first metered dilution fluid Fd1 pours into the first mixing chamber 14 already containing the metered sample Fe, the mixture obtained forming the first mixture of fluid Fm1 as illustrated in FIG. 18. The steps of resetting the first metering member 16 and metering the first dilution fluid Fd1 are carried out as many times as is necessary depending on the required rate of dilution. For example, for a ten-fold dilution of 10 μl of sample Fe, with a determined volume of the first metering member of 10 μl, nine dosages of the first dilution fluid Fd1 are needed to obtain 90 μl of dilution fluid to be mixed with the 10 μl of sample, thus forming a first mixture of fluid Fm1.

FIGS. 19 to 26 illustrate the second part of the dilution process, consisting of diluting the first mixture of fluid Fm1 obtained previously. Thus, in FIG. 19, the mechanical valves V3, V5, V6 and V8 are closed, and the mechanical valve V4 is opened. Pressure is then exerted on the first mixing chamber 14 so that part of the first mixture or fluid Fm1 present in said first mixing chamber 14 is conveyed into the second metering member 17 and metered. When the first mixture of fluid Fm1 fills the second metering member 17, the fragile valve positioned at the level of the first fluid inlet 17a of the second metering member 17 opens, and the fragile valves positioned respectively at the level of the second fluid inlet 17b and fluid outlet 17c also open under the action of the fluid Fm1 and of the metering zone which deforms to the operating state.

Under the pressure exerted by the arrival of the first mixture of fluid Fm1, the fragile valve positioned at the level of the first inlet 17a of the second metering member opens, as is illustrated in FIG. 20, and the metering zone of the second metering member 17 fills completely as for the first metering member 16 in FIG. 13. The valve V4 is closed as soon as the metering zone is filled. The metering zone of the second metering member 17 is in the operating state since the walls 101, 102 of the latter are at a distance from each other in order to define a metering volume as illustrated in FIG. 10, and all of the fragile valves positioned at the fluid inlet 17a, 17b and at the fluid outlet 17c of the second metering member 17 are opened and taken over respectively by the mechanical valves V4, V5 and V6 which are closed, in order to isolate the precise quantity of mixture of fluid Fm1 that is required.

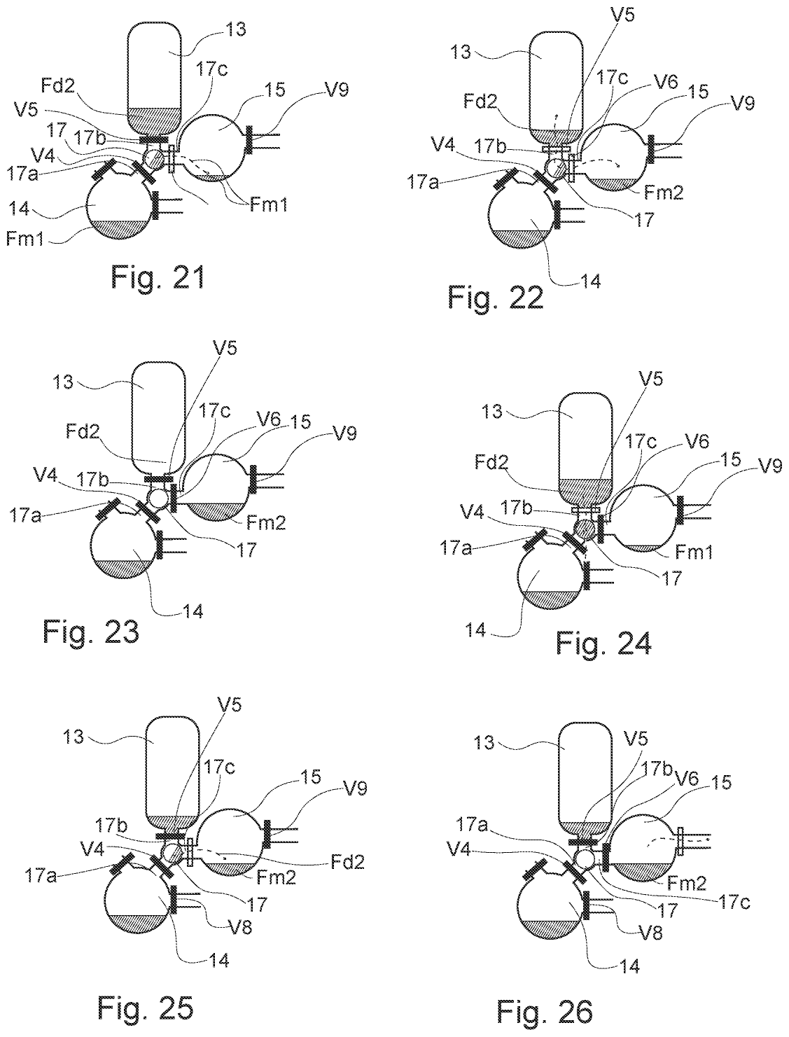

According to a first mode of operation illustrated in FIG. 22, the mechanical valves V5 and V6 are open even though the second metering member 17 still contains the first mixture of fluid Fm1, the mechanical valve V4 being closed. A back-and-forth motion is then effected between the second dilution fluid Fd2 contained in the third container 13, the second metering member 17 and the second mixing chamber 15, in such a way as to mix the second dilution fluid Fd2 with the first metered mixture of fluid Fm1, in order to obtain a second mixture of fluid Fm2.

When the second mixture of fluid Fm2 is obtained and is collected in the second mixing chamber 15, the mechanical valves V5 and V6 are closed, as is illustrated in FIG. 23.

Alternatively, according to a second mode of operation, once the first mixture of fluid Fm1 is metered into the second metering member 17, the mechanical valve V6 positioned at the fluid outlet 17c of the second metering member 17 is open, such that the first mixture of fluid Fm1 pours into the second mixing chamber 15, the mechanical valves V4 and V5 being closed, as is illustrated in FIG. 21. The mechanical valve V5 positioned at the second fluid inlet 17b of the second metering member 17 is then opened, the mechanical valve V6 being open and the mechanical valve V4 being closed, and the back-and-forth movement as illustrated in FIG. 22 and explained according to the first mode of operation above is carried out. When the second mixture of fluid Fm2 is obtained and is collected in the second mixing chamber 15, the mechanical valves V5 and V6 are closed, as is illustrated in FIG. 23.

Alternatively, according to a third mode of operation, once the first mixture of fluid Fm1 is metered in the second metering member 17, the mechanical valve V6 positioned at the fluid outlet 17c of the second metering member 17 is opened so that the first mixture of fluid Fm1 pours into the second mixing chamber 15, the mechanical valves V4 and V5 being closed, as is illustrated in FIG. 21. The metering zone of the second metering member 17 is then reset such that it is in the initial state, but with the fragile valves inactive, since their opening is irreversible. This reset can be achieved by a pusher element driving the walls of the device onto each other at the level of the metering zone. The mechanical valve V5 positioned at the second fluid inlet 17b of the second metering member 17 is then opened, the mechanical valves V4 and V6 remaining closed. The opening of the mechanical valve V6 involves the metering zone of the second metering member 17 passing to the operating state, making it possible to sample only a precise dose of the second dilution fluid Fd2 contained in the third container 13, as is illustrated in FIG. 24. Once the volume of the metering zone has been filled, the mechanical valve V5 is closed in order to isolate the dose of second dilution fluid Fd2 in the second metering member 17, the mechanical valves V4 and V6 also being closed.

In this third mode of operation, provision can be made that the second metering member 17 is emptied by pressure exerted on its metering zone, this pressure being able to be exerted by the same pusher element that serves for resetting or by another element.

The mechanical valve V6 is then opened so that the second metered dilution fluid Fd2 pours into the second mixing chamber 15 already containing the first metered mixture of fluid Fm1, as is illustrated in FIG. 25, the mixture obtained forming the second mixture of fluid Fm2, as is illustrated in FIG. 26.

The steps of resetting the second metering member 17 and of metering the first dilution fluid Fd1 are carried out as many times as is necessary depending on the required rate of dilution. In the present case, in order to obtain a hundred-fold dilution of the sample Fe, the second dilution fluid Fd2 is metered nine times for a single dosage of the first mixture of fluid Fm1, when the determined volume of the second metering member 17 is 10 μl.

Once the dilution process is completed and the volume of the second mixture of fluid Fm2 is obtained, the valve V9 is opened at the outlet of the second mixing chamber 15, and the second mixture of fluid Fm2 pours via the fluidic channel 23 into the wells of the dedicated row or rows 104 of the reaction chamber 103, as is illustrated in FIG. 29.

According to the invention, when one opts for a mode of operation with a reciprocal movement as described according to the first modes of operation of the first part of the dilution process and of the second part of the dilution process, and also as described according to the second modes of operation of the first part of the dilution process and of the second part of the dilution process, the dilution fluid (Fd1 or Fd2) first needs to be metered before its introduction into the container (12 or 13), so that, when the mixture of fluid is obtained, the container remains empty.

According to the invention, when one opts for a mode of operation with the metering of the dilution fluid, as described according to the third modes of operation of the first part and of the second part of the dilution process, one avoids metering the dilution fluid before its introduction into the container, which is less restrictive.

To ensure that the detection of the analyte or analytes sought in the collected sample is complete and reliable, it is necessary to compare the second mixture of fluid Fm2, which is the final result of the dilution, with the fluids from the preceding steps. Thus, in one or more rows 104 of dedicated wells, some of the sample Fe without dilution is collected, which is conveyed via the fluidic channel 21, as is illustrated in FIG. 27. The fluid outlet of the first container 11, as illustrated in the figures, comprises a bifurcation with two branches: a first branch is connected to the first fluid inlet 16a of the metering member 16, and a second branch constitutes the channel 21 directly connecting the first container 11 to the reaction chamber 103. A valve V7 is positioned downstream of the bifurcation on the channel 21, such that, when the sample Fe is conveyed to the first metering member 16, the fluid is directed only into the first branch.

Furthermore, the first mixing chamber 14 comprises a second fluid outlet connected directly to the reaction chamber 103 via a channel 22. A valve V8 isolates the channel 22 when the latter is not in use. Thus, some of the first mixture of fluid Fm1, which is conveyed via the fluidic channel 22, as illustrated in FIG. 28, is also collected in one or more rows 104 of dedicated wells. These collections can be carried out during the dilution process or after the dilution process.

For the dilution system according to the first configuration, it is possible to proceed according to any of the three modes of operation described above.

For the dilution system according to the second configuration, the first mode of operation is recommended, namely that the quantity of dilution fluid Fd1 and Fd2 must first be measured before introduction into the dilution system.

For the dilution system according to the fourth configuration, the metering member 16 must be reset at least between the two dilutions, as is explained with reference to the third mode of operation, in order to permit the metering of at least the sample fluid Fe and the first mixture of fluid Fm1; for the other fluids (Fd1, Fd2), it is possible to proceed according to any one of the three modes of operation with metering or back and forth movement.

The method of manufacturing the device 100 according to the invention will now be described with reference to FIGS. 30 to 35. The manufacturing method described is valid irrespective of the configuration of the dilution system integrated into the device according to the invention.

As has previously been mentioned, the device 100 is in the form of a flexible bag consisting of at least two films 101, 102. The “bag” comprises several compartments corresponding to the containers 11, 12, 13, to the mixing chambers 14, 15, to the metering members 16, 17, to the fluidic channels, and to a placement for the insertion of a reaction chamber 103.

To form the device 100, the two films 101, 102 are laminated over a part of the height of said device in the form of a bag, then the fluidic circuit including the various compartments (containers, mixing chamber, metering member, channels) of said bag is welded by permanent welding. Fragile valves are also placed at the fluid inlets and outlets of the metering members 16, 17.

To create the containers 11, 12, 13, a fluid, preferably a gas such as compressed air, possibly heated, is blown between the two films 101, 102 at the level of the markings of each container 11, 12, 13, the upper portion of each container being non-laminated and thus leaving an opening between the two films 101, 102. During the blowing, said bag is inserted into a mold having mold cavities with the impression of each container, in such a way that they conform to the impression during the blowing.

The creation of the metering members 16, 17 is independent of the creation of the containers, that is to say it can be carried out without the containers being formed. To create the metering members, the procedure is as follows.

In a first step, a deformation zone D on the bag is created by the marking each metering member 16, 17, like a ring, the deformation zone D delimiting the location of the metering member 16, 17 to be formed, as is shown in FIGS. 30 and 33.

In a second step, at least the deformation zone D created is positioned in a mold 200. The mold 200 comprises at least two mold parts 201, 202, each having respectively at least one mold cavity 201a, 202a, the cavity 201a of the first mold part 201 being arranged at least partially facing the cavity 202a of the second mold part 202, as is illustrated in FIGS. 30 and 33.

In a third step, the two films 101, 102 of the bag 100 are deformed together at the level of the deformation zone D by a deformation element 203, 204 toward the first mold part 201, the deformation element 203, 204 being arranged between the bag 100 and the second mold part 202, as is illustrated in FIGS. 31 and 34.

According to a first embodiment, the deformation of the bag 100 is carried out by sinking by an external deformation element 203, which is a lug protruding from the surface of the cavity 202a of the second mold part 202. The shape of the protruding lug 203 is adapted to the shape of the metering member 16, 17 that is to be create; for example, the protruding lug is in the form of a ball, at least one hemispherical portion of which protrudes from the second mold part 202, as is illustrated in particular in FIGS. 30 to 32.

According to the first embodiment, each metering member 16, 17 is produced by external deformation by a dedicated external deformation element 203, as can be seen in FIG. 32. In particular, and as is illustrated in FIG. 32, two protruding lugs 203, preferably of a ball shape, are positioned on the second mold part 202. These lugs are arranged so that, when the bag is inserted into the mold, they are each located facing a deformation zone D in order to create one metering member each. Advantageously, the first mold part 201 comprises counter-forms in its mold cavity 201a in order to accompany the deformation of the deformation zone D.

According to a second embodiment, illustrated in FIGS. 33 to 35, the deformation of the bag is achieved by blowing, the external deformation element 204 being a fluid. Preferably, the external deformation element 204 is a gas and even more preferably air.

Advantageously, the fluid serving for the formation of the containers is used, and it is reused/or some of it is diverted for the deformation of the metering member. The fluid passes between the second mold part 202 and one of the films 102 of the bag 100, as can be seen in FIG. 34.

In FIG. 35, the cavity 202a of the second mold part 202 comprises an open channel 205 intended to be positioned opposite the first mold part 201, the fluid 204 configured to deform the bag 100 being blown into said open channel 205. In fact, the open channel 205 is configured to guide the fluid 204 constituting the external deformation element 204 as far as the deformation zone D of each metering member 16, 17. In the example illustrated, the open channel 205 distributes zones of deformation; nevertheless, other forms of channel may be envisioned without thereby departing from the scope of protection of the invention.

Of course, the invention is not restricted to the embodiments described and shown in the accompanying figures. Modifications remain possible, in particular as regards the makeup of the various elements or by substitution of technical equivalents, without thereby departing from the scope of protection of the invention.

1. A dilution system for diluting a sample of biological material, comprising a fluidic circuit, wherein the fluidic circuit comprises at least:
a first container configured to contain a sample of biological material containing a biological material to be diluted, the sample being a fluid,
a second container configured to contain a first dilution fluid,
the first container and the second container being fluidically connected by at least one fluid path,
at least a first metering member for metering a determined volume of fluid, comprising a first wall and a second wall, the first metering member comprising a metering zone configured to change at least from an initial state, in which the first wall and the second wall are in contact against each other, to an operating state, in which the first wall and the second wall are at a distance from each other in such a way as to delimit a determined metering volume, the metering zone attaining the operating state by the conveying of the sample and/or of a dilution fluid into the metering zone, the first metering member being arranged on the fluid path connecting the first container to the second container, between the first container and the second container.

2. The dilution system as claimed in claim 1, in which the first metering member comprises a fluid inlet connected directly to the first container, and a fluid inlet connected directly to the second container.

3. The dilution system as claimed in claim 2, in which each fluid inlet of the first metering member, in the initial state of the metering zone of the first metering member, is hermetically closed by a fragile valve, each fragile valve being configured to be opened by the pressure of a fluid, from between the sample or the dilution fluid, conveyed to the first metering member.

4. The dilution system as claimed in claim 1, comprising at least a first mixing chamber configured to contain a first mixture of fluid resulting from the mixing of part of the sample and at least part of the first dilution fluid, the first mixing chamber being fluidically connected to the first container and to the second container.

5. The dilution system as claimed in claim 4, in which the first metering member comprises at least one fluid outlet connected to the first mixing chamber, each fluid outlet of the first metering member, in the initial state of the metering zone of the first metering member, is hermetically closed by a fragile valve, each fragile valve being configured to be opened by the pressure of a fluid, from between the sample or the first dilution fluid, conveyed toward the first mixing chamber.

6. The dilution system as claimed in claim 4, comprising a third container, configured to contain a second dilution fluid and at least a second mixing chamber configured to contain a second mixture of fluid resulting from the mixing of part of the first mixture of fluid and at least part of the second dilution fluid, the second mixing chamber being fluidically connected to the first mixing chamber and to the third container.

7. The dilution system as claimed in claim 6, comprising a second metering member arranged upstream of the second mixing chamber, the second metering member being configured to meter the first mixture of fluid coming from the first mixing chamber and intended to be diluted by the second dilution fluid coming from the third container.

8. A device in the form of a flexible bag comprising at least a first film and a second film laminated with each other at least partially, wherein the device comprises the dilution system as claimed in claim 1, and a reaction chamber, the dilution system being fluidically connected to the reaction chamber, and the reaction chamber of the device comprising a plurality of wells configured to accommodate at least one reagent.

9. The device as claimed in claim 8, wherein it is configured to cooperate with a first plurality of mechanical valves positioned upstream of each fragile valve of the first metering member, each mechanical valve is placed at a fluid inlet or a fluid outlet of the first metering member and is configured to allow/prohibit a fluid to enter the first metering member or to allow/prohibit a fluid to exit the first metering member.

10. The device as claimed in claim 8, wherein it is configured to cooperate with a second plurality of mechanical valves positioned upstream of the fragile valves of the second metering member, each mechanical valve of the plurality is placed at a fluid inlet or a fluid outlet of the second metering member and is configured to allow/prohibit a fluid to enter the second metering member or to allow/prohibit a fluid to exit the second metering member.

11. A method for manufacturing a device as claimed in claim 8, the manufacturing method comprising:
at least one step of creating the fluidic circuit of the dilution system on the films of the device, by welding the films, the films being at least partially laminated beforehand,
at least one step of forming at least the first metering member, in which: (i) at least the metering zone of the first metering member created in the step of creating the fluidic circuit is positioned in a mold, the mold comprising at least two mold parts, each having at least one mold cavity, the mold cavity of the first mold part being arranged at least partially facing the mold cavity of the second mold part and being at least partially complementary to the mold cavity of the second mold part, (ii) by closing the two parts of the mold toward each other, the two films of the device are deformed together on one side or the other of the device, in a single direction of deformation, at the level of the metering zone by a deformation element, the deformation element being arranged between the device and the second mold part or between the device and the first mold part.

12. The method as claimed in claim 11, in which the deformation of the metering zone of each metering member of the dilution system is effected by die sinking by the deformation element.

13. The method as claimed in claim 12, in which the deformation element is a protruding lug provided on the first mold part or on the second mold part, the lug protruding from the surface of the mold cavity of the first mold part or the second mold part, respectively.

14. The method as claimed in claim 13, in which the deformation element is a fluid, and the deformation of the metering zone is effected by blowing of the fluid.

15. The method as claimed in claim 14, in which the second mold part or the first mold part comprises an open channel provided on the surface facing the first mold part or the second mold portion, respectively, the fluid configured to deform the one or more metering zones being blown and guided into the open channel.
